(19) United States
(12) Patent Application Publication
(10) Pub. No.: US 2026/0021803 A1
(43) Pub. Date: Jan. 22, 2026

(54) Parking Assistance Method and Parking Assistance Device

(71) Applicant: Nissan Motor Co., Ltd., Yokohama-shi, Kanagawa (JP)

(72) Inventors: Yasuhiro Suzuki, Kanagawa (JP); Manato Matsumoto, Kanagawa (JP); Yusuke Musha, Kanagawa (JP)

(21) Appl. No.: 18/995,520

(22) PCT Filed: Jul. 19, 2022
(86) PCT No.: PCT/JP2022/028102

§ 371 Date: Jan. 16, 2025

(51) Int. Cl. B60W 30/06; B60W 50/08; G01C 21/36; G08G 1/14

(52) U.S. Cl. CPC B60W 30/06; B60W 50/08; G01C 21/3685; G08G 1/14; B60W 2530/18; B60W 2540/215

(57) ABSTRACT

A parking assistance method includes: setting a self-position at a point where the detection precision of the self-position being greater than or equal to a predetermined precision changes to less than the predetermined precision, as first self-position; detecting a relative positional relationship between a target object existing in surroundings of a target parking position when the own vehicle is parked at the target parking position after the first self-position is set and the target parking position; when the detection precision is less than a predetermined precision when the own vehicle stops at the target parking position, storing the first self-position and learned target object data representing the relative positional relationship, in association with each other in a storage device; and when the first self-position and the learned target object data are stored in association with each other, assisting parking based on the first self-position and the learned target object data.

### TECHNICAL FIELD

The present invention relates to a parking assistance method and a parking assistance device.

### BACKGROUND

In WO 2017/072941 A1 described below, a parking assistance device that detects a self-position of an own vehicle, based on positioning information and that performs parking assistance when determining that the self-position comes close to a target parking position registered in advance in a storage device is described.

### SUMMARY

In a technology in WO 2017/072941 A1 described above, there is a risk that when the detection precision of the self-position is low, it becomes difficult to determine whether or not a registered target parking position is located close to the own vehicle. An object of the present invention is to enable whether or not a registered target parking position is located close to an own vehicle to be determined at a place where detection precision of a self-position is low.

According to an aspect of the present invention, there is provided a parking assistance method including: detecting a self-position of an own vehicle; estimating detection precision of the self-position; setting the self-position at a point where a state in which the detection precision is greater than or equal to a predetermined precision changes to a state in which the detection precision is less than the predetermined precision, as a first self-position; detecting a relative positional relationship between a target object existing in surroundings of a target parking position when the own vehicle is parked at the target parking position after the first self-position is set and the target parking position; when the detection precision is less than a predetermined precision when the own vehicle comes to a stop at the target parking position, storing the first self-position and learned target object data, the learned target object data being data representing the relative positional relationship, in association with each other in a storage device; and when the first self-position and the learned target object data are stored in association with each other, assisting parking of the own vehicle at the target parking position, based on the first self-position and the learned target object data.

According to an aspect of the present invention, it is possible to enable whether or not a registered target parking position is located close to an own vehicle to be determined at a place where detection precision of a self-position is low.

### BRIEF DESCRIPTION OF THE DRAWINGS

FIG. 1 is a diagram illustrative of a schematic configuration example of a parking assistance device;

FIG. 2A is an explanatory diagram of an example of processing of registering a target parking position;

FIG. 2B is an explanatory diagram of an example of processing performed when parking assistance is performed;

FIG. 3 is a block diagram of an example of a functional configuration of a controller in FIG. 1;

FIG. 4A is a schematic diagram of a situation in which detection precision of a self-position deteriorates;

FIG. 4B is another schematic diagram of the situation in which the detection precision of the self-position deteriorates;

FIG. 5A is an explanatory diagram of processing performed when the parking assistance at a target parking position is performed;

FIG. 5B is an explanatory diagram of processing performed when the parking assistance at another target parking position is performed;

FIG. 6 is a flowchart of an example of processing of storing learned target object data; and

FIG. 7 is a flowchart of an example of processing performed when the parking assistance is performed.

### DETAILED DESCRIPTION

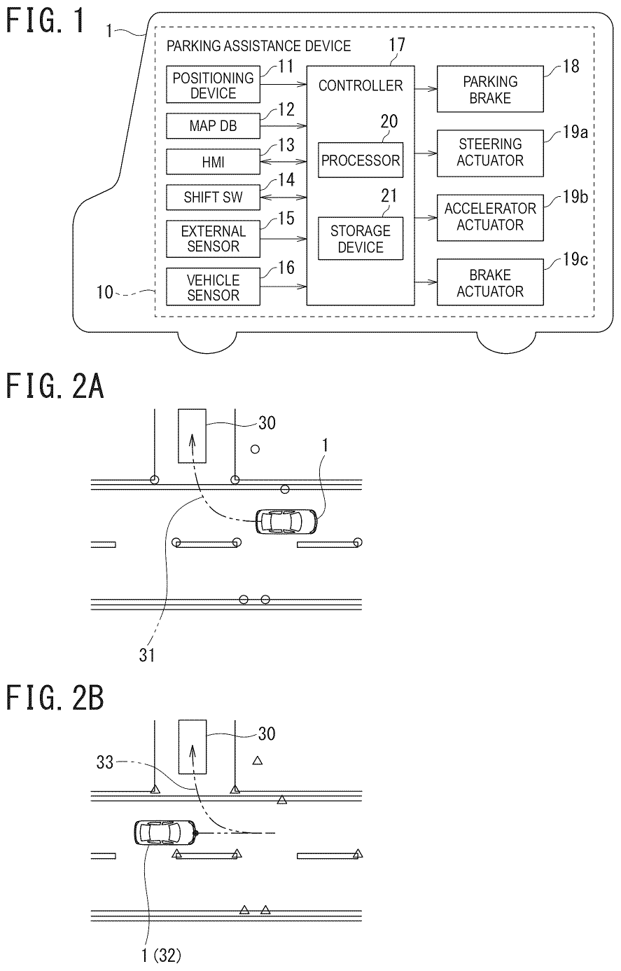

FIG. 1 is now referred to. An own vehicle 1 includes a parking assistance device 10 configured to assist parking of the own vehicle 1 at a target parking position. The parking assistance device 10 assists the own vehicle 1 in traveling along a target travel trajectory from a current position of the own vehicle 1 to the target parking position. For example, the parking assistance device 10 may perform autonomous driving in which the own vehicle 1 is controlled to autonomously travel to the target parking position along the target travel trajectory of the own vehicle 1 (that is, control to cause the own vehicle 1 to control all or some of a steering angle, driving force, and braking force thereof and autonomously perform all or a portion of travel of the own vehicle 1 along the target travel trajectory). Alternatively, the parking assistance device 10 may assist parking of the own vehicle 1 by displaying the target travel trajectory and the current position of the own vehicle 1 on a display device that a passenger of the own vehicle 1 can visually recognize.

A positioning device 11 measures a self-position that is the current position of the own vehicle 1. The positioning device 11 may include a global navigation satellite system (GNSS) receiver, such as a global positioning system (GPS) receiver, or may measure a self-position by receiving position information from wireless local area network (LAN) access points or mobile phone base stations. In a map database (map DB) 12, map data are stored. The map data stored in the map database 12 may be high-definition map data that is suitable as, for example, a map for autonomous driving. Human-machine interfaces (HMIs) 13 are interface devices that transfer information between the parking assistance device 10 and the passenger. A shift switch (shift SW) 14 is a switch for the passenger (for example, a driver) of the own vehicle 1 or the parking assistance device 10 to switch a shift position of the own vehicle 1.

External sensors 15 detect an object existing in a predetermined distance range from the own vehicle 1. The external sensors 15 detect a surrounding environment of the own vehicle 1, such as a relative position between an object existing in surroundings of the own vehicle 1 and the own vehicle 1, distance between the own vehicle 1 and the object, and a direction in which the object exists. The external sensors 15 may include, for example, a camera to capture an image depicting the surrounding environment of the own vehicle 1. In the following description, the camera included in the external sensors 15 is simply referred to as “camera”. The external sensors 15 may include a ranging device, such as a laser range finder, a radar, and a LiDAR. Vehicle sensors 16 detect various information (vehicle information) about the own vehicle 1. The vehicle sensors 16 may include, for example, a vehicle speed sensor, wheel speed sensors, a triaxial acceleration sensor, a steering angle sensor, a turning angle sensor, a gyro sensor, and a yaw rate sensor.

A controller 17 is an electronic control unit that performs parking assistance control. The controller 17 includes a processor 20 and peripheral components, such as a storage device 21. The processor 20 may be, for example, a CPU or an MPU. The storage device 21 may include a semiconductor storage device, a magnetic storage device, an optical storage device, or the like. Functions of the controller 17 may be achieved by, for example, the processor 20 executing computer programs stored in the storage device 21. A steering actuator 19a controls steering direction and the amount of steering of a steering mechanism of the own vehicle 1 in accordance with a control signal from the controller 17. An accelerator actuator 19b controls accelerator opening of a drive device, which is an engine or a drive motor, in accordance with a control signal from the controller 17. A brake actuator 19c causes a braking device to operate in accordance with a control signal from the controller 17.

Next, the parking assistance control performed by the parking assistance device 10 will be described. When the parking assistance performed by the parking assistance device 10 is used, a target parking position at which the own vehicle 1 is to be parked is registered in the parking assistance device 10. Specifically, a target object existing in the surroundings of the target parking position is extracted and stored in the storage device 21 in advance. In the following description, a target object in the surroundings of the target parking position to be stored in the storage device 21 is referred to as “learned target object”.

FIG. 2A is an explanatory diagram of an example of processing of registering the target parking position, and circular marks represent learned target objects. When a target parking position 30 is registered in the parking assistance device 10, the passenger performs an operation to instruct registration of the target parking position 30 (hereinafter, sometimes referred to as “registration operation”). The registration operation may, for example, be an operation of a “parking position registration switch” that is prepared in the HMIs 13.

example, the parking assistance device 10 detects a target object in the surroundings of the own vehicle 1 by the external sensors 15 and stores a detected target object as a learned target object when the own vehicle 1 is positioned in a vicinity of the target parking position 30 (for example, when the passenger parks the own vehicle 1 at the target parking position 30 by manual driving). For example, the parking assistance device 10 may detect a target object from a surrounding image that is obtained by capturing the surroundings of the own vehicle 1 by the camera. The parking assistance device 10 may detect a target object in the surroundings of the own vehicle 1, using the ranging device. The parking assistance device 10 stores learned target object data relating to a learned target object in the storage device 21. For example, the learned target object data include data representing a feature amount of a learned target object (hereinafter, referred to as “feature amount data”), data representing a relative positional relationship between the learned target object and the target parking position (hereinafter, referred to as “relative position data”), and coordinate data of the target parking position 30 (hereinafter, referred to as “target parking position coordinate data”) in a coordinate system with reference to a fixed point (hereinafter, referred to as “map coordinate system”).

As the relative position data, a relative position of a learned target object with reference to the target parking position 30 may be stored. For example, the parking assistance device 10 can acquire a position of a learned target object detected when the own vehicle 1 is positioned at the target parking position 30 as a relative position of the learned target object with reference to the target parking position 30. The parking assistance device 10 may store coordinates of a learned target object and the target parking position 30 in the map coordinate system. The parking assistance device 10 may store the self-position of the own vehicle 1 when the own vehicle 1 is positioned at the target parking position 30, as the target parking position coordinate data. On this occasion, when detection precision of the positioning device 11 is greater than or equal to a predetermined precision, the parking assistance device 10 may store the self-position of the own vehicle 1 measured by the positioning device 11, and when the detection precision of the positioning device 11 is less than the predetermined precision, the parking assistance device 10 may store a self-position of the own vehicle 1 estimated by odometry, such as dead reckoning.

FIG. 2B is an explanatory diagram of an example of the processing performed when the parking assistance is performed. The parking assistance device 10 starts the parking assistance for the own vehicle 1 when the own vehicle 1 is positioned in the vicinity of the registered target parking position 30 and an operation by the passenger to instruct start of the parking assistance control to assist parking of the own vehicle 1 at the target parking position 30 (hereinafter, sometimes referred to as “starting operation”) is performed. The start operation may be, for example, an operation of a “parking assistance start switch” prepared in the HMIs 13 or may be shift operation for turnabout in which forward movement and backward movement of the own vehicle 1 are switched.

The parking assistance device 10 extracts a target object in the surroundings of the own vehicle 1 by the external sensors 15. In the following description, a target object in the surroundings of the own vehicle 1 that is extracted when the parking assistance is performed is referred to as “surrounding target object”. In FIG. 2B, triangular marks represent surrounding target objects. The parking assistance device 10 matches a learned target object and a surrounding target object with each other and associates the same feature points with each other. The parking assistance device 10 calculates a relative position of the own vehicle 1 with respect to the target parking position 30, based on a relative positional relationship between a surrounding target object detected when the parking assistance is performed and the own vehicle 1 and a relative positional relationship between a learned target object associated with the surrounding target object and the target parking position 30. For example, the parking assistance device 10 calculates a position of the target parking position 30 in a coordinate system with reference to the current position of the own vehicle 1 (hereinafter, referred to as “vehicle coordinate system”). Note that when coordinates of the learned target object and the target parking position 30 in the map coordinate system are stored in the storage device 21, the parking assistance device 10 may convert the coordinates of the target parking position 30 in the map coordinate system to coordinates in the vehicle coordinate system, based on the position of the surrounding target object detected when the parking assistance is performed and the position of the learned target object in the map coordinate system. The parking assistance device 10 may calculate the self-position of the own vehicle 1 in the map coordinate system, based on the position of the surrounding target object detected when the parking assistance is performed and the position of the learned target object in the map coordinate system, and calculate the relative position of the own vehicle 1 with respect to the target parking position 30 from a difference between the coordinates of the own vehicle 1 and the coordinates of the target parking position 30 in the map coordinate system.

The parking assistance device 10 calculates a target travel trajectory 33 starting from a current position 32 of the own vehicle 1 and reaching the target parking position 30, based on the relative position of the own vehicle 1 with respect to the target parking position 30. The parking assistance device 10 performs the parking assistance control of the own vehicle 1, based on the calculated target travel trajectory 33.

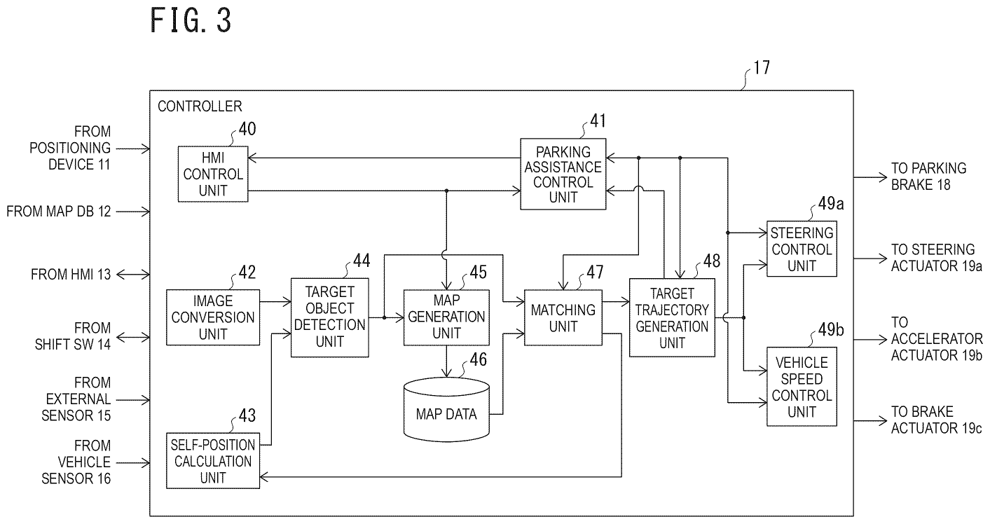

A functional configuration of the controller 17 will be described in detail below. FIG. 3 is now referred to. When an HMI control unit 40 detects a registration operation of a target parking position 30 performed by the passenger, the HMI control unit 40 outputs a map generation command to cause learned target object data to be stored in the storage device 21 to a map generation unit 45. When the HMI control unit 40 detects a starting operation of the parking assistance control to assist parking of the own vehicle 1 at a registered target parking position 30, the HMI control unit 40 outputs a control start command to start the parking assistance control to assist parking of the own vehicle 1 at the target parking position 30, to a parking assistance control unit 41. An image conversion unit 42 converts a captured image captured by the camera to an overhead view image that is an image viewed from a virtual viewpoint directly above the own vehicle 1. The image conversion unit 42 generates a surrounding image that is an image depicting the surrounding region of the own vehicle 1 by converting a captured image to an overhead view image at a predetermined interval and accumulating converted overhead view images along a travel route of the own vehicle 1.

A self-position calculation unit 43 calculates the current position of the own vehicle 1 in the map coordinate system as a self-position by odometry (for example, dead reckoning) based on vehicle information output from the vehicle sensors 16. The self-position calculation unit 43 corrects a calculation result of the self-position, based on a detection result of the self-position detected by the positioning device 11. The self-position calculation unit 43 estimates detection precision of the positioning device 11. When, for example, the positioning device 11 includes a GNSS receiver, the self-position calculation unit 43 may estimate the detection precision of the positioning device 11, based on the number of captured navigation satellites. When the positioning device 11 performs positioning, based on position information from wireless LAN access points or mobile phone base stations, the self-position calculation unit 43 may estimate the detection precision of the positioning device 11, based on the number of captured wireless LAN access points or mobile phone base stations and reception strength of position information. The map generation unit 45 and a matching unit 47, which will be described later, may also estimate the detection precision of the positioning device 11 in the same manner as in the self-position calculation unit 43.

The parking assistance device 10 may detect the self-position of the own vehicle 1, using the high-definition map data in place of or in addition to the positioning device 11. For example, the parking assistance device 10 may detect a target object in the surroundings of the own vehicle 1 by the external sensors 15 and detect the self-position of the own vehicle 1 by map matching between the detected target object and the high-definition map data. In this case, the parking assistance device 10 may estimate detection precision of positioning based on the high-definition map data, based on accuracy of the map matching (for example, matching error).

The target object detection unit 44 detects a target object from a surrounding image output from the image conversion unit 42. The target object detection unit 44 may detect a position of a feature point of a target object and an image feature amount of the feature point as a target object. The target object detection unit 44 outputs the detected position and image feature amount of the feature point to the map generation unit 45 and the matching unit 47 as target object data. In addition, the target object detection unit 44 outputs the self-position acquired from the self-position calculation unit 43 in synchronization with the detection of the target object to the map generation unit 45 and the matching unit 47.

When the map generation unit 45 receives a map generation command from the HMI control unit 40 (that is, when the registration operation of the target parking position 30 is performed), the map generation unit 45 generates learned target object data and stores the generated learned target object data in the storage device 21 as map data 46. For example, the map generation unit 45 receives, from the target object detection unit 44, target object data and the self-position of the own vehicle 1 in the map coordinate system that is synchronous with the target object data. The map generation unit 45 acquires position information of the target parking position 30 in the map coordinate system. The map generation unit 45 may acquire a self-position that the self-position calculation unit 43 calculates when the own vehicle 1 is positioned at the target parking position 30 as position information of the target parking position 30. The map generation unit 45 generates relative position data, based on a position of a feature point included in the target object data, position information of the own vehicle 1 synchronous with the position of the feature point, and position information of the target parking position 30. In addition, the map generation unit 45 acquires feature amount data from the target object data output from the target object detection unit 44. The map generation unit 45 uses the position information of the target parking position 30 as target parking position coordinate data. The map generation unit 45 stores learned target object data including the above-described relative position data, feature amount data, and target parking position coordinate data in the storage device 21 as the map data 46.

When the parking assistance control unit 41 receives a control start command from the HMI control unit 40, the parking assistance control unit 41 outputs a parking position calculation command to the matching unit 47. The matching unit 47 receives target object data output from the target object detection unit 44 as target object data of a surrounding target object and also receives the self-position of the own vehicle 1 in the map coordinate system in synchronization with the reception of the target object data. The matching unit 47 determines whether or not the own vehicle 1 is positioned in the vicinity of the registered target parking position 30, based on the target parking position coordinate data included in the learned target object data stored in the storage device 21. In addition, the matching unit 47 may, by comparing feature amount data included in the learned target object data stored in the storage device 21 with target object data of a target object in the surroundings of the own vehicle 1 that are output from the target object detection unit 44, determine whether or not the own vehicle 1 is positioned in an area in which a target object that can be matched with the learned target object data in the vicinity of the target parking position 30 is detected.

When the own vehicle 1 is positioned in the vicinity of the registered target parking position 30 or the own vehicle 1 is positioned in an area in which a target object that can be matched with the learned target object data is detected, the matching unit 47 matches a learned target object with a surrounding target object and associates target objects having the same feature point with each other. The matching unit 47 calculates a relative position of the own vehicle 1 with respect to the target parking position 30, based on a relative positional relationship between a surrounding target object and the own vehicle 1 and a relative positional relationship between a learned target object associated with the surrounding target object and the target parking position 30. For example, surrounding target objects are denoted by (xᵢ, yᵢ), and learned target objects each of which is associated with one of the surrounding target objects (xᵢ, yᵢ) are denoted by (xₘᵢ, yₘᵢ) (i=1 to N). The matching unit 47 calculates an affine transformation matrix M_{affine}, using the following equation, based on a least-square method.

$$\begin{matrix}\begin{matrix}[ \begin{matrix}{a}_{1} \\ {a}_{2} \\ {a}_{3} \\ {a}_{4}\end{matrix} ] = {[ \begin{matrix}{X}_{X}^{T} & {X}_{X}\end{matrix} ]}^{- 1} {X}_{X}^{T} {X}_{tfm} \\ \end{matrix} \\ \begin{matrix}{X}_{X} = [ \begin{matrix}{x}_{m 1} & {y}_{m 1} & 1 & 0 \\ {y}_{m 1} & - {x}_{m 1} & 0 & 1 \\ ⋮ & ⋮ & ⋮ & ⋮ \\ {x}_{mN} & {y}_{mN} & 1 & 0 \\ {y}_{mN} & - {x}_{mN} & 0 & 1\end{matrix} ] & {X}_{tfm} = [ \begin{matrix}{x}_{1} \\ {y}_{1} \\ ⋮ \\ {x}_{N} \\ {y}_{N}\end{matrix}\end{matrix} ] \\ {M}_{affine} = [ \begin{matrix}{a}_{1} & {a}_{2} & {a}_{3} \\ - {a}_{2} & {a}_{1} & {a}_{4}\end{matrix} ]\end{matrix} \qquad [ Math 1 ]$$

The matching unit 47 converts a position (targetxₘ, targetyₘ) of the target parking position 30 in the map coordinate system, which is stored in the map data 46, to a position (targetx, targety) in the vehicle coordinate system, using the following equation.

$$\{ \begin{matrix}targetx \\ targety\end{matrix} \} = {M}_{affine} \{ \begin{matrix}{targetx}_{m} \\ {targety}_{m} \\ 1\end{matrix} \} \qquad [ Math 2 ]$$

The target trajectory generation unit 48 calculates a target travel trajectory starting from the current position of the own vehicle 1 and reaching the target parking position 30 in the vehicle coordinate system and a target vehicle speed profile. A steering control unit 49a controls the steering actuator 19a in such a way that the own vehicle 1 travels along the target travel trajectory. A vehicle speed control unit 49b controls the accelerator actuator 19b and the brake actuator 19c in such a way that vehicle speed of the own vehicle 1 changes in accordance with the target vehicle speed profile. When the own vehicle 1 reaches the target parking position 30 and the parking assistance control is completed, the parking assistance control unit 41 causes a parking brake 18 to operate and switches the shift position to a parking range (P range).

Next, processing in a case where the detection precision of the self-position deteriorates will be described. For example, when the positioning device 11 detects the self-position of the own vehicle 1, using GNSS receivers, wireless LAN access points, or the like, there is a risk that the detection precision of the self-position deteriorates in an indoor parking lot (for example, an underground parking lot). When the self-position is detected using the high-definition map data, there is a risk that the detection precision of the self-position deteriorates at a place for which the high-definition map data are not sufficiently developed.

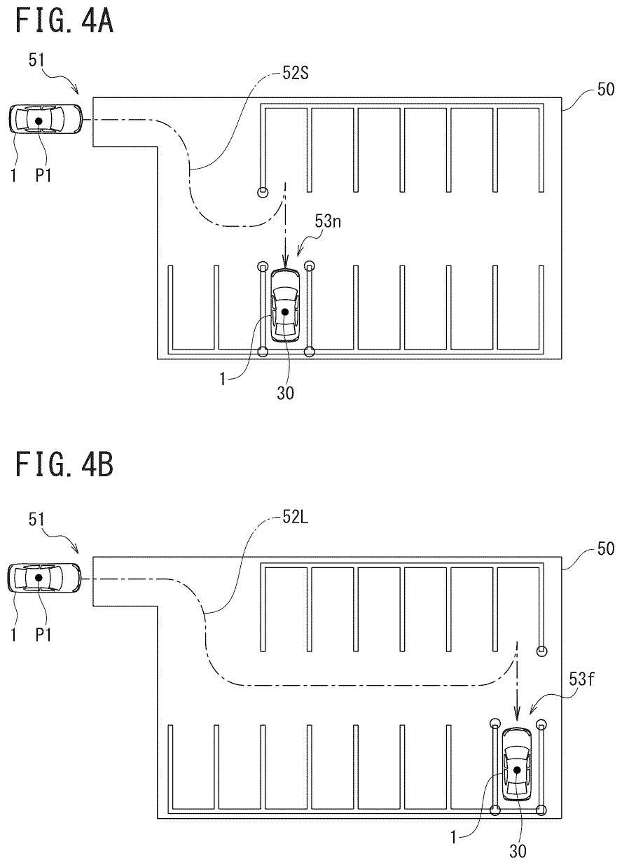

FIGS. 4A and 4B are schematic diagrams of situations in each of which a target parking position 30 is to be stored in an indoor parking lot 50. In an example in FIG. 4A, a target parking position 30 in a parking slot 53n in which the own vehicle 1 is to be parked after entering the indoor parking lot 50 from an entrance 51 and traveling along a comparatively short travel track 52S is stored, and in an example in FIG. 4B, a target parking position 30 in a parking slot 53f in which the own vehicle 1 is to be parked after traveling a comparatively long travel track 52L is stored.

When the detection precision of the self-position by the positioning device 11 or the high-definition map data is low, the self-position calculation unit 43 becomes unable to correct the self-position calculated by odometry. Thus, error is accumulated in a calculation result of the self-position as travel distance of the own vehicle 1 increases, and positional precision of the target parking position 30 stored as the target parking position coordinate data in the learned target object data deteriorates. Positional precision of the self-position at a time point when the parking assistance control is performed also deteriorates. As a result, there is a risk that when the parking assistance control is performed, the matching unit 47 becomes unable to determine whether or not the own vehicle 1 is positioned in the vicinity of the registered target parking position 30.

Therefore, when the map generation unit 45 determines that a state in which the detection precision of the self-position is greater than or equal to a predetermined precision has changed to a state in which the detection precision of the self-position is less than the predetermined precision, the map generation unit 45 sets a self-position detected at a point where the state in which the detection precision is greater than or equal to the predetermined precision changes to the state in which the detection precision is less than the predetermined precision, as a first self-position P1. For example, the map generation unit 45 may set a self-position detected immediately before the state in which the detection precision of the self-position is greater than or equal to the predetermined precision changes to the state in which the detection precision of the self-position is less than the predetermined precision, as the first self-position P1. For example, the map generation unit 45 may temporarily store a self-position detected immediately before the state in which the detection precision of the self-position is greater than or equal to the predetermined precision changes to the state in which the detection precision of the self-position is less than the predetermined precision, as the first self-position P1.

After setting the first self-position P1, the map generation unit 45 determines whether or not to generate learned target object data and store the generated learned target object data in the storage device 21. For example, when the detection precision is less than the predetermined precision when the own vehicle 1 comes to a stop at the target parking position 30, the map generation unit 45 may store information about the first self-position P1 and the learned target object data in association with each other in the storage device 21. For example, the map generation unit 45 may determine whether or not the passenger has performed the registration operation while the detection precision is less than the predetermined precision. When the map generation unit 45 determines to generate learned target object data and store the generated learned target object data in the storage device 21 while the detection precision is less than the predetermined precision, the map generation unit 45 stores information about the first self-position P1 and the learned target object data in association with each other in the storage device 21.

For example, the map generation unit 45 may determine whether or not to generate learned target object data and store the generated learned target object data in the storage device 21 in a situation in which after the state in which the detection precision of the self-position is greater than or equal to the predetermined precision changes to the state in which the detection precision of the self-position is less than the predetermined precision at the first self-position P1, the state in which the detection precision is less than the predetermined precision continues. For example, the map generation unit 45 may determine whether or not the passenger has performed the registration operation in a situation in which the state in which the detection precision is less than the predetermined precision continues. When the map generation unit 45 determines to generate learned target object data and store the generated learned target object data in the storage device 21 in a situation in which the state in which the detection precision is less than the predetermined precision continues, the map generation unit 45 may store information about the first self-position P1 and the learned target object data in association with each other in the storage device 21.

Because of this configuration, the learned target object data at the target parking position 30 registered while the detection precision is less than the predetermined precision and the position information (the first self-position P1) detected with a precision greater than or equal to the predetermined precision can be stored in association with each other in the storage device 21. As a result, even at a place where the detection precision of the self-position is less than the predetermined precision, by checking whether or not the self-position of the own vehicle 1 is located in a vicinity of the first self-position P1, whether or not a registered target parking position 30 exists in a vicinity of the self-position of the own vehicle 1 can be determined and the learned target object data can be retrieved from the storage device 21. For example, a point where the state in which the detection precision is greater than or equal to the predetermined precision has changed to the state in which the detection precision of the self-position is less than the predetermined precision is temporarily stored. When the parking assistance control is started, the learned target object data at the registered target parking position 30 can be retrieved by matching the stored point with the first self-position P1. In addition, when a plurality of target parking positions 30 are registered in the storage device 21, a target parking position 30 that is registered at a place where the detection precision of the self-position is less than the predetermined precision can be correctly selected.

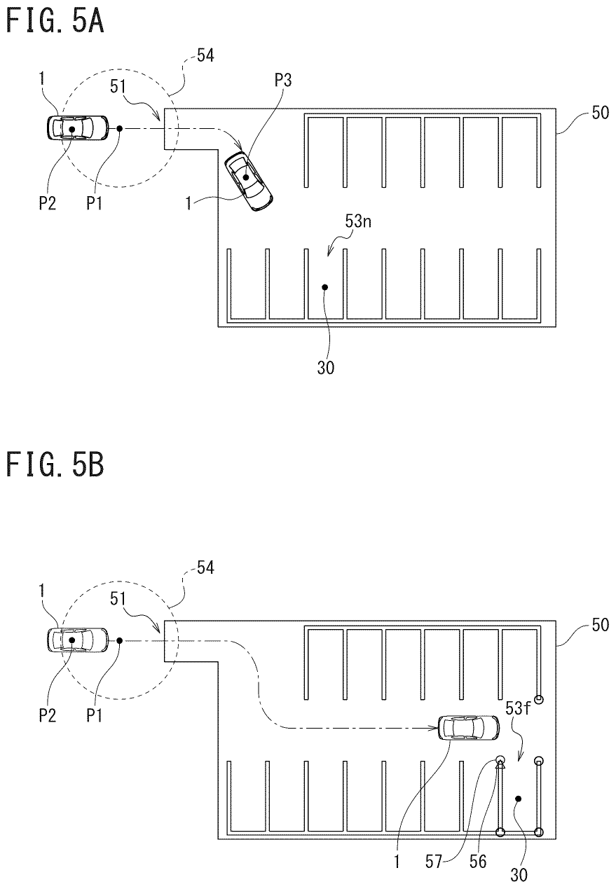

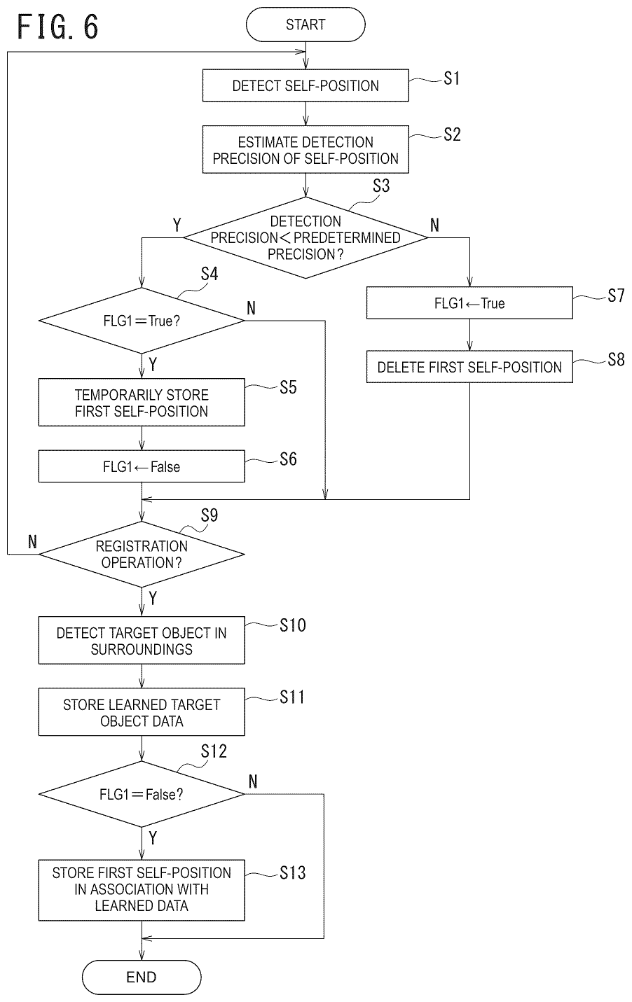

FIGS. 5A and 5B are schematic diagrams of situations in each of which the parking assistance control to assist parking of the own vehicle 1 at a target parking position 30 is performed at a time point after the target parking position 30 is registered. The positioning device 11 detects a self-position (in the following description, sometimes referred to as “second self-position”) P2 of the own vehicle 1 at a time point after a target parking position 30 is registered. The second self-position P2 may be detected using the high-definition map data in place of or in addition to the positioning device 11.

An area 54 illustrated by a dashed line in each of FIGS. 5A and 5B indicates an area in which distance from the first self-position P1 is less than or equal to a first threshold value Dt1. When distance between the second self-position P2 and the first self-position P1 becomes less than or equal to the first threshold value Dt1, the matching unit 47 retrieves learned target object data stored in association with the first self-position P1 from the storage device 21. Because of this configuration, by checking whether or not the self-position of the own vehicle 1 is located in the vicinity of the first self-position P1, the learned target object data at the target parking position 30 registered as a target parking position in the indoor parking lot 50 can be retrieved from the storage device 21.

For example, the matching unit 47 may estimate detection precision of the second self-position P2 and determine whether or not the state in which the detection precision is greater than or equal to the predetermined precision has changed to the state in which the detection precision is less than the predetermined precision. When distance between the second self-position P2 detected immediately before the detection precision changes to a precision less than the predetermined precision and the first self-position P1 becomes less than or equal to the first threshold value Dt1, the matching unit 47 may retrieve the learned target object data stored in association with the first self-position P1 from the storage device 21.

For example, when the state in which the detection precision of the second self-position P2 is greater than or equal to the predetermined precision has changed to the state in which the detection precision of the second self-position P2 is less than the predetermined precision, the matching unit 47 may determine whether or not the first self-position P1 stored in the storage device 21 exists within a distance of the first threshold value Dt1 from the second self-position P2 detected immediately before the detection precision changes to a precision less than the predetermined precision. That is, the matching unit 47 may identify the first self-position P1 existing within a distance of the first threshold value Dt1 from the second self-position P2.

At a time point when the matching unit 47 subsequently receives a parking position calculation command (that is, a time point when the starting operation is accepted), the matching unit 47 may retrieve the learned target object data stored in association with the identified first self-position P1 from the storage device 21.

For example, when the state in which the detection precision of the second self-position P2 is greater than or equal to the predetermined precision has changed to the state in which the detection precision of the second self-position P2 is less than the predetermined precision and the distance between the second self-position P2 detected immediately before the detection precision changes to a precision less than the predetermined precision and the first self-position P1 becomes the first threshold value Dt1, the matching unit 47 may temporarily store the second self-position P2. At a time point when the matching unit 47 subsequently receives a parking position calculation command, the matching unit 47 may retrieve the learned target object data stored in association with the first self-position P1 existing within a distance of the first threshold value Dt1 from the second self-position P2, from the storage device 21.

As described above, in the self-position that the self-position calculation unit 43 calculates by odometry, calculation error is accumulated as travel distance of the own vehicle 1 increases. Thus, even when the detection precision of the self-position by the positioning device 11 or the high-definition map data becomes less than the predetermined precision and it becomes difficult to correct a calculation result of the self-position, it is possible to expect that the positional precision of the self-position calculated by the self-position calculation unit 43 is high before the travel distance of the own vehicle 1 becomes long. For example, in the situation illustrated in FIG. 5A, the travel distance of the own vehicle 1 from when the detection precision of the self-position becomes less than the predetermined precision until the own vehicle 1 comes close to a registered target parking position 30 is short. Thus, whether or not the own vehicle 1 is sufficiently close to the target parking position 30 (that is, whether or not the matching unit 47 can match a surrounding target object with a learned target object at the target parking position 30) can be determined with high precision. On the other hand, in the situation illustrated in FIG. 5B, the travel distance of the own vehicle 1 until the own vehicle 1 comes close to a target parking position 30 is long and the positional precision of the self-position that the self-position calculation unit 43 calculates has deteriorated. Thus, whether or not the own vehicle 1 has come sufficiently close to the target parking position 30 cannot be determined.

Therefore, the matching unit 47 may calculate a travel distance that the own vehicle 1 has traveled after the state in which the detection precision of the second self-position P2 is greater than or equal to the predetermined precision changed to the state in which the detection precision is less than the predetermined precision. When the calculated travel distance is less than or equal to a second threshold value Dt2, the matching unit 47 may retrieve learned target object data from the storage device 21, based on the self-position of the own vehicle 1 that the self-position calculation unit 43 calculates by odometry. For example, the matching unit 47 may compare the self-position of the own vehicle 1 calculated by odometry with the target parking position coordinate data in the learned target object data stored in the storage device 21 and retrieve the learned target object data at a target parking position 30 in the vicinity of the self-position of the own vehicle 1 from the storage device 21.

For example, the matching unit 47 determines whether or not the own vehicle 1 is positioned in a vicinity of a registered target parking position 30 by comparing the self-position of the own vehicle 1 that the self-position calculation unit 43 calculates by odometry with the target parking position coordinate data in the learned target object data stored in the storage device 21. When the own vehicle 1 is positioned in the vicinity of the registered target parking position 30 and a starting operation by the passenger is accepted, the matching unit 47 retrieves the learned target object data at the target parking position 30 in the vicinity of the own vehicle 1 from the storage device 21 and the parking assistance device 10 performs the parking assistance for the own vehicle 1.

In contrast, when the travel distance after the detection precision of the second self-position P2 becomes less than the predetermined precision exceeds the second threshold value Dt2, the matching unit 47 may retrieve, among the learned target object data stored in association with the first self-position P1 existing within a distance less than or equal to the first threshold value Dt1 from the second self-position P2 detected immediately before the detection precision changes to a precision less than the predetermined precision, learned target object data of a target object having a feature amount similar to a feature amount of a surrounding target object in the surroundings of the own vehicle 1, from the storage device 21.

Specifically, the matching unit 47 compares feature amount data of a learned target object 57 in the learned target object data at the target parking position 30 that are stored in the storage device 21 in association with the first self-position P1 existing within a distance less than or equal to the first threshold value Dt1 from the second self-position P2 with a feature amount of a surrounding target object 56 detected in the surroundings of the own vehicle 1 when the parking assistance is performed. The matching unit 47 determines whether or not the own vehicle 1 is positioned in the vicinity of the target parking position 30, based on whether or not the feature amount of the surrounding target object resembles the feature amount data. When a plurality of target parking positions 30 stored in the storage device 21 in association with the first self-position P1 existing within a distance less than or equal to the first threshold value Dt1 from the second self-position P2 exist, the matching unit 47 determines, with respect to all of the plurality of target parking positions 30, whether or not the own vehicle 1 is positioned in the vicinity of the target parking position 30.

When the own vehicle 1 is determined to be positioned in the vicinity of the target parking position 30 and the starting operation by the passenger is accepted, the matching unit 47 retrieves the learned target object data at the target parking position 30 in the vicinity of the own vehicle 1 from the storage device 21 and the parking assistance device 10 performs the parking assistance for the own vehicle 1.

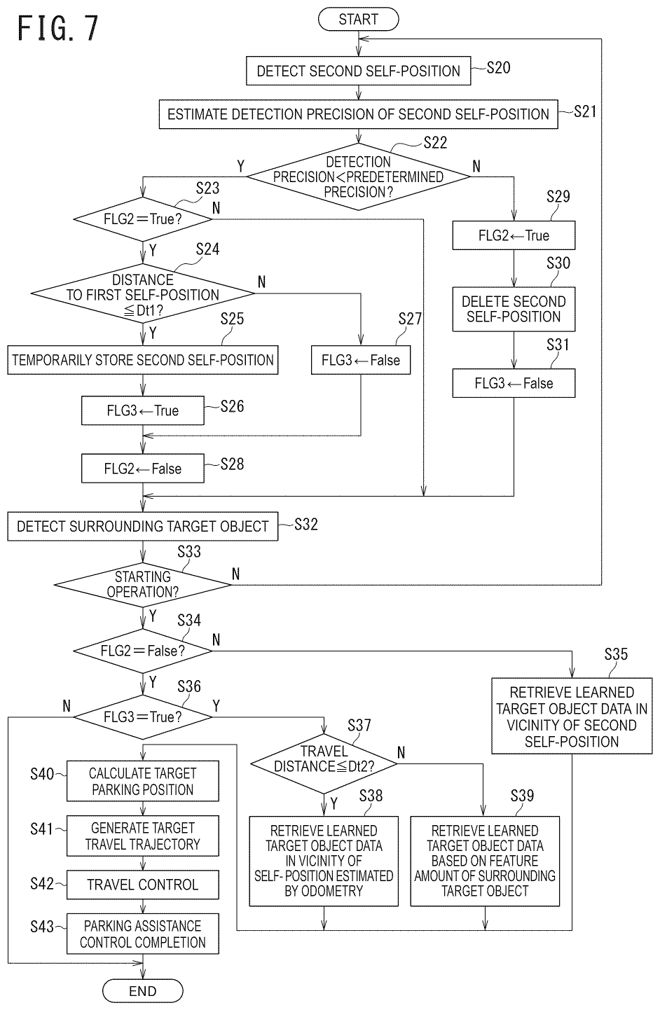

FIG. 6 is now referred to. In step S1, the positioning device 11 detects a self-position. In step S2, the map generation unit 45 estimates detection precision of the self-position. When the detection precision is less than a predetermined precision (step S3: Y), the process proceeds to step S4. When the detection precision is greater than or equal to the predetermined precision (step S3: N), the process proceeds to step S7. In step S4, the map generation unit 45 determines whether or not a value of a first flag FLG1 is True. The first flag FLG1 is a determination value that is set to True or False in a predetermined step in a flowchart. For example, the value of FLG1 is set to False in step S6, and the value of FLG1 is set to True in step S7. When the value of the first flag FLG1 is True (step S4: Y), the process proceeds to step S5. When the value of the first flag FLG1 is False (step S4: N), the process proceeds to step S9.

In step S5, the map generation unit 45 temporarily stores the self-position detected in step S1 as a first self-position P1. In step S6, the map generation unit 45 sets the value of the first flag FLG1 to False. Subsequently, the process proceeds to step S9. In step S7, the map generation unit 45 sets the value of the first flag FLG1 to True. In step S8, the map generation unit 45 deletes the first self-position P1 stored in step S5. Subsequently, the process proceeds to step S9.

In step S9, the HMI control unit 40 determines whether or not a passenger has performed a registration operation. When the passenger has performed the registration operation (step S9: Y), the process proceeds to step S10. When the passenger has not performed the registration operation (step S9: N), the process returns to step S1. In step S10, the target object detection unit 44 detects a target object in the surroundings of a target parking position 30. In step S11, the map generation unit 45 generates learned target object data and stores the generated learned target object data in the storage device 21. In step S12, the map generation unit 45 determines whether or not the value of the first flag FLG1 is False. When the value of the first flag FLG1 is False (step S12: Y), the process proceeds to step S13. When the value of the first flag FLG1 is True (step S12: N), the process terminates. In step S13, the map generation unit 45 stores information about the first self-position P1 temporarily stored in step S5, in the storage device 21 in association with the learned target object data stored in step S11. Subsequently, the process terminates.

FIG. 7 is now referred to. In step S20, the positioning device 11 detects a second self-position P2. In step S21, the matching unit 47 estimates detection precision of the second self-position P2. When the detection precision is less than a predetermined precision (step S22: Y), the process proceeds to step S23. When the detection precision is greater than or equal to the predetermined precision (step S22: N), the process proceeds to step S29. In step S23, the matching unit 47 determines whether or not a value of a second flag FLG2 is True. The second flag FLG2 is a determination value that is set to True or False in a predetermined step in the flowchart. For example, the value of FLG2 is set to False in step S28, and the value of FLG2 is set to True in step S29. When the value of the second flag FLG2 is Truc (step S23: Y), the process proceeds to step S24. When the value of the second flag FLG2 is False (step S23: N), the process proceeds to step S32.

In step S24, the matching unit 47 determines whether or not distance between the second self-position P2 and the first self-position P1 is less than or equal to the first threshold value Dt1. When the distance between the second self-position P2 and the first self-position P1 is less than or equal to the first threshold value Dt1 (step S24: Y), the process proceeds to step S25. When the distance between the second self-position P2 and the first self-position P1 is not less than or equal to the first threshold value Dt1 (step S24: N), the process proceeds to step S27. In step S25, the matching unit 47 temporarily stores the second self-position P2. In step S26, the matching unit 47 sets a value of a third flag FLG3 to Truc. The third flag FLG3 is a determination value that is set to True or False in a predetermined step in the flowchart. For example, the value of FLG3 is set to True in step S26, and the value of FLG3 is set to False in steps S27 and S31. Subsequently, the process proceeds to step S28. In step S27, the matching unit 47 sets the value of the third flag FLG3 to False. Subsequently, the process proceeds to step S28. In step S28, the matching unit 47 sets the value of the second flag FLG2 to False. Subsequently, the process proceeds to step S32.

In step S29, the matching unit 47 sets the value of the second flag FLG2 to True. In step S30, the matching unit 47 deletes the second self-position P2 previously stored in step S25. In step S31, the matching unit 47 sets the value of the third flag FLG3 to False. Subsequently, the process proceeds to step S32.

In step S32, the target object detection unit 44 detects a surrounding target object existing in the surroundings of the own vehicle 1. In step S33, the HMI control unit 40 determines whether or not the passenger has performed a starting operation. When the passenger has performed the starting operation (step S33: Y), the process proceeds to step S34. When the passenger has not performed the starting operation (step S33: N), the process returns to step S20.

In step S34, the matching unit 47 determines whether or not the value of the second flag FLG2 is False. When the value of the second flag FLG2 is False (step S34: Y), the process proceeds to step S36. When the value of the second flag FLG2 is True (step S34: N), the process proceeds to step S35. In step S35, the matching unit 47 retrieves learned target object data at a registered target parking position 30 in a vicinity of the second self-position P2 that is the current position of the own vehicle 1, from the storage device 21. Subsequently, the process proceeds to step S40.

In step S36, the matching unit 47 determines whether or not the value of the third flag FLG3 is Truc. When the value of the third flag FLG3 is True (step S36: Y), the process proceeds to step S37. When the value of the third flag FLG3 is False (step S36: N), the process terminates.

In step S37, the matching unit 47 determines whether or not travel distance after the detection precision of the second self-position P2 becomes less than a predetermined precision is less than or equal to a second threshold value Dt2. When the travel distance is less than or equal to the second threshold value Dt2 (step S37: Y), the process proceeds to step S38. When the travel distance is not less than or equal to the second threshold value Dt2 (step S37: N), the process proceeds to step S39. In step S38, the matching unit 47 retrieves learned target object data from the storage device 21, based on the self-position that the self-position calculation unit 43 calculates by odometry. Subsequently, the process proceeds to step S40. In step S39, the matching unit 47 retrieves, among learned target object data stored in association with the first self-position P1 existing within a distance less than or equal to the first threshold value Dt1 from the second self-position P2 stored in step S25, learned target object data of a target object having a feature amount similar to a feature amount of a surrounding target object, from the storage device 21. Subsequently, the process proceeds to step S40.

In step S40, the matching unit 47 calculates a relative position of the own vehicle 1 with respect to the target parking position 30 by matching the surrounding target object with the learned target object data. In step S41, the target trajectory generation unit 48 calculates a target travel trajectory and a target vehicle speed profile. In step S42, the steering control unit 49a and the vehicle speed control unit 49b control the steering actuator 19a, the accelerator actuator 19b, and the brake actuator 19c, based on the target travel trajectory and the target vehicle speed profile. In step S43, when the parking assistance control is completed, the parking assistance control unit 41 causes the parking brake 18 to operate and switches the shift position to the P range. Subsequently, the process terminates.

### Advantageous Effects of Embodiment

(1) According to the parking assistance method described in claim 1, even at a place where the detection precision of the self-position is less than the predetermined precision, whether or not a registered target parking position exists in a vicinity of the own vehicle 1 can be determined and learned target object data can be retrieved from the storage device.

According to the parking assistance method described in claim 2, even at a place where the detection precision of the self-position is less than the predetermined precision, parking of the own vehicle 1 at a registered target parking position can be assisted using the learned target object data at the target parking position.

According to the parking assistance method described in claim 3, even at a place where the detection precision of the self-position is less than the predetermined precision, parking of the own vehicle 1 at a registered target parking position can be assisted using the learned target object data at the target parking position.

(2) According to the parking assistance method described in claim 4, even when the parking assistance control is started at a time point after the own vehicle 1 enters a place where the detection precision of the self-position is less than the predetermined precision, the learned target object data can be retrieved from the storage device.

According to the parking assistance method described in claim 5, even when the parking assistance control is started at a time point after the own vehicle 1 enters a place where the detection precision of the self-position is less than the predetermined precision, the learned target object data can be retrieved from the storage device.

(3) According to the parking assistance method described in claim 6, when travel distance after the own vehicle 1 enters a place where the detection precision of the self-position is less than the predetermined precision is comparatively short, the learned target object data can be efficiently retrieved from the storage device.

(4) According to the parking assistance method described in claim 7, even when travel distance after the own vehicle 1 enters a place where the detection precision of the self-position is less than the predetermined precision is comparatively long, the learned target object data can be retrieved from the storage device.

(5) According to the parking assistance method described in claim 8, learned target object data at a target parking position registered at a place where the detection precision of the self-position is less than the predetermined precision can be correctly selected.

### REFERENCE SIGNS LIST

1 Own vehicle
10 Parking assistance device
17 Controller

1. A parking assistance method comprising:
detecting a self-position of an own vehicle;
estimating detection precision of the self-position;
setting the self-position at a point where a state in which the detection precision is greater than or equal to a predetermined precision changes to a state in which the detection precision is less than the predetermined precision, as a first self-position;
detecting a relative positional relationship between a target object existing in surroundings of a target parking position when the own vehicle is parked at the target parking position after the first self-position is set and the target parking position;
when the detection precision is less than a predetermined precision when the own vehicle comes to a stop at the target parking position, storing the first self-position and learned target object data, the learned target object data being data representing the relative positional relationship, in association with each other in a storage device; and
when the first self-position and the learned target object data are stored in association with each other, assisting parking of the own vehicle at the target parking position, based on the first self-position and the learned target object data.

2. The parking assistance method according to claim 1 comprising:
detecting a second self-position, the second self-position being the self-position of the own vehicle at a time point later than a learning time point, the learning time point being a time point when the learned target object data are stored;
when distance between the second self-position and the first self-position becomes less than or equal to a first threshold value, retrieving the learned target object data stored in association with the first self-position from the storage device;
detecting a position of a surrounding target object, the surrounding target object being a target object existing in surroundings of the own vehicle at a time point later than the learning time point;
calculating a relative positional relationship between the target parking position and a current position of the own vehicle, based on the learned target object data and a position of the surrounding target object;
calculating a travel trajectory starting from a current position of the own vehicle and reaching the target parking position, based on a relative positional relationship between the target parking position and a current position of the own vehicle; and
assisting parking of the own vehicle at the target parking position, based on the travel trajectory.

3. The parking assistance method according to claim 2 comprising:
estimating detection precision of the second self-position; and
when a state in which detection precision of the second self-position is greater than or equal to the predetermined precision changes to a state in which the detection precision is less than the predetermined precision and distance between the second self-position and the first self-position becomes less than or equal to the first threshold value, retrieving the learned target object data stored in association with the first self-position from the storage device.

4. The parking assistance method according to claim 3 comprising:
when a state in which detection precision of the second self-position is greater than or equal to the predetermined precision changes to a state in which the detection precision is less than the predetermined precision, identifying the first self-position existing within a distance of the first threshold value from the second self-position; and
when an operation instructing detection of the target parking position is accepted from a passenger, retrieving the learned target object data stored in association with the identified first self-position from the storage device.

5. The parking assistance method according to claim 1 comprising:
when a second self-position, the second self-position being the self-position of the own vehicle at a time point later than a learning time point, the learning time point being a time point when the learned target object data are stored, is detected, a state in which detection precision of the second self-position is greater than or equal to the predetermined precision changes to a state in which the detection precision is less than the predetermined precision, and distance between the second self-position and the first self-position becomes less than or equal to a first threshold value, storing the second self-position;
when an operation instructing detection of the target parking position is accepted from a passenger, retrieving the learned target object data stored in association with the first self-position existing within a distance less than or equal to the first threshold value from the stored second self-position from the storage device;
detecting a position of a surrounding target object, the surrounding target object being a target object existing in surroundings of the own vehicle at a time point later than the learning time point;
calculating a relative positional relationship between the target parking position and a current position of the own vehicle, based on the learned target object data and a position of the surrounding target object;
calculating a travel trajectory starting from a current position of the own vehicle and reaching the target parking position, based on a relative positional relationship between the target parking position and a current position of the own vehicle; and
assisting parking of the own vehicle at the target parking position, based on the travel trajectory.

6. The parking assistance method according to claim 2, wherein the learned target object data include position data of the target parking position, and the parking assistance method comprises:
estimating detection precision of the second self-position; and
retrieving, when travel distance traveled by the own vehicle after a state in which detection precision of the second self-position is greater than or equal to the predetermined precision changes to a state in which the detection precision is less than the predetermined precision is less than or equal to a second threshold value, the learned target object data from the storage device, based on a self-position of the own vehicle estimated by odometry of the own vehicle.

7. The parking assistance method according to claim 2, wherein the learned target object data include data of a feature amount of a target object existing in surroundings of the target parking position, the parking assistance method comprises:
estimating detection precision of the second self-position, and
retrieving, when travel distance traveled by the own vehicle after a state in which detection precision of the second self-position is greater than or equal to the predetermined precision changes to a state in which the detection precision is less than the predetermined precision is greater than a second threshold value, the learned target object data having a feature amount similar to a feature amount of the surrounding target object among the learned target object data stored in association with the first self-position from the storage device.

8. The parking assistance method according to claim 2 comprising:
storing the learned target object data at a plurality of the target parking positions in the storage device; and
when distance between the second self-position and the first self-position becomes less than or equal to a first threshold value, retrieving the learned target object data stored in association with the first self-position among the learned target object data at the plurality of target parking positions from the storage device.

9. A parking assistance device comprising:
a storage device; and
a controller configured to perform processing including:
acquiring position information obtained by positioning a self-position, the self-position being a current position of an own vehicle;
estimating detection precision of the self-position;
setting the self-position at a point where a state in which the detection precision is greater than or equal to a predetermined precision changes to a state in which the detection precision is less than the predetermined precision, as a first self-position;
detecting a relative positional relationship between a target object existing in surroundings of a target parking position when the own vehicle is parked at the target parking position after the first self-position is set and the target parking position;
when the detection precision is less than a predetermined precision when the own vehicle comes to a stop at the target parking position, storing the first self-position and learned target object data, the learned target object data being data representing the relative positional relationship, in association with each other in the storage device; and
when the first self-position and the learned target object data are stored in association with each other, assisting parking of the own vehicle at the target parking position, based on the first self-position and the learned target object data.
